(19) United States
(12) Patent Application Publication
(10) Pub. No.: US 2020/0006912 A1
(43) Pub. Date: Jan. 2, 2020

(54) AN OPTICAL PLURAL-COMB GENERATOR, A METHOD OF GENERATING AN OPTICAL PLURAL COMB, AND A PLURALITY OF MODE LOCKED LASERS THAT ARE MECHANICALLY COUPLED AND OPTICALLY INDEPENDENT

(71) Applicant: UNIVERSITY OF SOUTH AUSTRALIA, Adelaide, South Australia (AU)

(72) Inventors: David LANCASTER, Salisbury Heights, South Australia (AU); Nicolas BOURBEAU HÉBERT, Trois-Rivéres, Québec QC (CA); Champak KHURMI, Pooraka, South Australia (AU); Jérome GENEST, Québec, Québec QC (CA)

(21) Appl. No.: 16/486,792

(22) PCT Filed: Feb. 27, 2018
(86) PCT No.: PCT/AU2018/050171

§ 371 Date: Aug. 16, 2019

(30) Foreign Application Priority Data
Feb. 27, 2017 (AU) 2017900651

(51) Int. Cl. H01S 3/23; H01S 3/02; H01S 3/11; H01S 3/063

(52) U.S. Cl. CPC H01S 3/2383; H01S 3/025; H01S 3/1608; H01S 3/0637; H01S 3/1118

(57) ABSTRACT

An optical plural-comb generator comprising a plurality of mode-locked lasers that are mechanically coupled and optically independent. The optical plural-comb generator comprises an optical combiner optically coupled to an output of each of the plurality of mode-locked lasers for combining a plurality of optical combs when generated by the plurality of mode-locked lasers.

### PRIORITY CLAIM

The present application is a National Phase entry of PCT Application No. PCT/AU2018/152594 A1, filed Feb. 27, 2018, which claims the benefit of Australian Patent Application No. 2017900651, filed Feb. 27, 2017, which are incorporated herein by reference.

### TECHNICAL FIELD

The disclosure herein generally relates to an optical plural-comb generator, a method of generating an optical plural comb, and a plurality of mode locked lasers that are mechanically coupled and optically independent.

### BACKGROUND

A mode-locked laser emits a kind of light called an optical comb (or alternatively an optical frequency comb). In the frequency domain, an optical comb comprises of a plurality of discrete, equally spaced optical frequency components. The comb spacing (and pulse repetition rate in the time domain) is proportional to the inverse of the length of the mode-locked laser cavity.

In a mode-locked laser there generally is a drift in the phase and spacing of the plurality of discrete equally spaced optical frequency components. The drift results from changes in the length of the optical resonator of the mode locked laser, and changes in the refractive indices of at least one of the intra-cavity optics, gain medium, and non-linear effects.

Stable optical frequency combs may be used for, for example, linking radio frequency standards to an optical frequency; optical metrology; molecular spectroscopy; and distance measurement. Electronically stabilized optical combs are commercially available, but they are bulky and expensive, which may preclude their use in many applications.

To achieve a stable optical comb, a mode locked laser may be actively stabilized, by, for example, ‘self-referencing’ or ‘carrier envelope offset’ stabilization. These techniques may add complexity and generally requires electronic control loops to stabilize the cavity length and phase of the light pulses.

Passive stabilization of mode-locked lasers has been attempted, but the required stability is generally not achieved. To date, un-stabilized or passive optical comb sources based on mode-locked lasers suffer drift and do not meet requirements for any known application.

Non-reciprocal optical resonators (for example, an optical ring) have been proposed for generating two slightly detuned combs from the same cavity. These laser designs, however, have not demonstrated a suitably stable optical dual comb source for use. An example is disclosed by Mehravar, S., Norwood, R., Peyghambarian, N. & Kieu, K. Real-time dual-comb spectroscopy with a free-running bidirectionally mode-locked fiber laser. Appl. Phys. Lett. 108, 231104 (2016). The two pulse trans intersect non-linearly in the laser cavity and this may lead to problems in obtaining calibrated and stable spectra.

Optical spectrometry may be performed using an optical comb. Optical dual comb spectroscopy is one of the few techniques able to resolve a complete set of dense frequency components, which may generally provide for a superior precision of frequency measurement. The principals of Optical dual comb spectroscopy are described by Coddington, I., Newbury, N. & Swann, W. (2016) Dual-comb spectroscopy. Optica 3(4), 414-426 and the citations therein. Dual comb interferometry also can be used for remote sensing, for example.

Optical dual-comb spectroscopy maps optical information to the more accessible radio-frequency domain using two mutually coherent optical combs which have slightly different or detuned repetition rates. The coherence may be achieved by phase locking the two optical combs together or to an external frequency reference. However, these techniques require external frequency references and/or hardware that add complexity and cost.

There is a need for stable optical comb sources that do not require electronic frequency stabilization or an independent optical frequency reference.

### SUMMARY

Disclosed herein is an optical plural-comb generator. The optical plural-comb generator comprises a plurality of mode-locked lasers that are mechanically coupled and optically independent. The optical plural-comb generator comprises an optical combiner optically coupled to an output of each of the plurality of mode-locked lasers for combining a plurality of optical combs when generated by the plurality of mode-locked lasers.

In an embodiment, the plurality of mode-locked lasers are cooperatively configured for externally generated mechanical perturbations to be synchronous for the plurality of mode-locked laser.

In an embodiment, the plurality of mode-locked lasers are cooperatively arranged for externally generated vibrations to be synchronous for the plurality of mode-locked lasers.

In an embodiment, the plurality of mode-locked lasers are cooperatively arranged such that the length of an optical resonator of each of the plurality of mode-locked lasers change at the same time and by the same amount in response to an externally generated vibration.

An embodiment is configured to eschew coupling of the optical comb from one of the plurality of mode locked lasers to another of one of the plurality of mode locked lasers.

In an embodiment, each of the plurality of mode-locked lasers comprise a waveguide formed in a piece of solid-state laser gain material common to the plurality of mode-locked lasers.

In an embodiment, the effective length of an optical resonator of one of the plurality of mode-locked lasers is 1 μm-100 μm greater than the effective length of another optical resonator of another one of the plurality of mode-locked lasers.

In an embodiment, the distance between the centers of adjacent waveguides of the plurality of the mode locked lasers is 100 μm to 1 mm.

In an embodiment, the distance between centers of adjacent waveguides of the plurality of mode locked lasers is 300 μm to 600 μm.

In an embodiment, the respective waveguide of each of the plurality of mode locked lasers has a length of less than 150 mm.

In an embodiment, the respective waveguide of each of the plurality of mode locked lasers has a length of less than 75 mm.

In an embodiment, the respective waveguide of each of the plurality of mode-locked lasers has a length of less than 20 mm.

In an embodiment, the respective waveguide of each of the plurality of mode-locked lasers has a length of at least 0.5 mm.

In an embodiment, the plurality of mode-locked lasers are arranged such that the plurality of optical combs when generated are incident on the piece of solid state laser gain material of at an angle in the range of 80 degrees and 90 degrees.

In an embodiment, a waveguide of one of the plurality of mode locked lasers has a different dimension than that of another waveguide of another one of the plurality of mode locked lasers.

In an embodiment, the different dimension comprises at least one of a different length and a different transverse dimension. A transverse dimension of a waveguide of one of the plurality of mode-locked lasers may be 1 μm to 25 μm greater than that of another one of the plurality of mode-locked lasers. The transverse dimension of the one of the plurality of waveguides may be 2.5 μm to 10 μm greater than the transverse dimension of the other one of the plurality of waveguides.

In an embodiment, an optical plural-comb generator defined by any one of the claims 6 to 18 wherein the transverse dimension of an optical core of each of the plurality of waveguides is 20 μm-100 μm.

In an embodiment, the length of an optical resonator of one of the plurality of mode-locked lasers is greater than that of another one of the plurality of mode-locked lasers.

In an embodiment, the effective length of an optical resonator of one of the plurality of mode-locked lasers is greater than that of another optical resonator of another one of the plurality of mode-locked lasers.

In an embodiment, an optical resonator of one of the plurality of mode-locked lasers and that of another one of the plurality of mode-locked lasers comprise shared optical resonator optical components.

An embodiment comprises a mode locking-device common to the plurality of mode-locked lasers.

In an embodiment, the mode-locking device is a passive mode-locking device.

In an embodiment, the mode-locking device comprises a saturable-absorber mirror.

In an embodiment, the plurality of mode-locked lasers are configured such that the plurality of optical combs each have a waist adjacent the mode-locking device.

In an embodiment, each of the plurality of mode-locked lasers comprises a reciprocal optical resonator.

In an embodiment, each of the plurality of optical combs when generated have a free-running frequency noise power spectral density of less than 1×10⁶ Hz²/Hz at frequencies between 1 kHz and 10 MHz, and less than 1×10⁴ Hz²/Hz at frequencies greater than 10 kHz.

An embodiment is configured for each of the plurality of optical combs to have a frequency noise of 10¹⁰ Hz²/Hz at 1 Hz.

In an embodiment, the plurality of optical combs when generated have a mutual Lorentzian linewidth of less than 50 Hz.

In an embodiment, the plurality of optical combs when generated have a mutual Lorentzian linewidth of greater than 20 Hz. In an embodiment, the common mode rejection of vibrations by the plurality of optical combs is in the range of 1 Hz to 10 KHz is at least two orders of magnitude.

In an embodiment, the mutual coherence of the two optical combs is greater than 1 s.

Disclosed herein is a method for generating an optical plural-comb. The method comprises the step of mechanically coupling a plurality of optically independent mode-locked lasers. The method comprises the step of operating the mechanically coupled plurality of optically independently mode-locked lasers thereby generating a plurality of optical combs The method comprises the step of combining the plurality of optical combs.

In an embodiment, the step of mechanically coupling the plurality of optically independent mode-locked lasers comprises cooperatively configuring the plurality of mode-locked lasers for externally generated mechanical perturbations to be synchronous for the plurality of mode-locked lasers.

In an embodiment, cooperatively configuring the plurality of mode-locked lasers comprises cooperatively configuring the plurality of mode-locked lasers for externally generated vibrations to be synchronous for the plurality of mode-locked lasers.

In an embodiment, the plurality of mode-locked lasers each comprise a respective waveguide formed in a piece of solid state gain material common to the plurality of mode-locked lasers.

An embodiment comprises the step of configuring the plurality of mode-locked lasers such that the plurality of optical combs are incident on the piece of solid state gain material at an angle in the range of 80 degrees and 90 degrees.

An embodiment comprises the step of forming an optical resonator of each of the plurality of mode-locked lasers from at least one shared optical component.

In an embodiment, the shared optical component comprises a mode-locking device.

An embodiment comprises the step of arranging the plurality of mode-locked lasers such that the plurality of optical combs have a waist adjacent the mode-locking device. The plurality of optical combs may have a waist coincident with the mode-locking device.

In an embodiment, the mode-locking device comprises a saturable-absorber mirror.

In an embodiment, each of the optically independent mode-locked lasers comprises a reciprocal optical resonator.

In an embodiment, each of the plurality of optical combs have a frequency noise of 10¹⁰ Hz²/Hz at 1 Hz.

Disclosed herein is a plurality of mode-locked lasers that are mechanically coupled and optically independent.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an embodiment of an optical plural-comb generator.

FIG. 2 shows an example of a plurality of mode-locked lasers that are mechanically coupled and optically independent that may be used in the optical plural comb generator of FIG. 1.

FIG. 3 shows the measured spectrum of two optical combs generated by the optical plural comb generator of FIG. 1.

FIG. 4 shows an averaged interferogram obtained using the optical plural-comb generator of FIG. 1.

FIG. 5 shows the spectrum of a pair of optical comb modes beating together at different times.

FIG. 6 shows another an example of a plurality of mode-locked lasers that are mechanically coupled and optically independent that may be used in the optical plural comb generator of FIG. 1.

### DESCRIPTION OF THE EMBODIMENTS

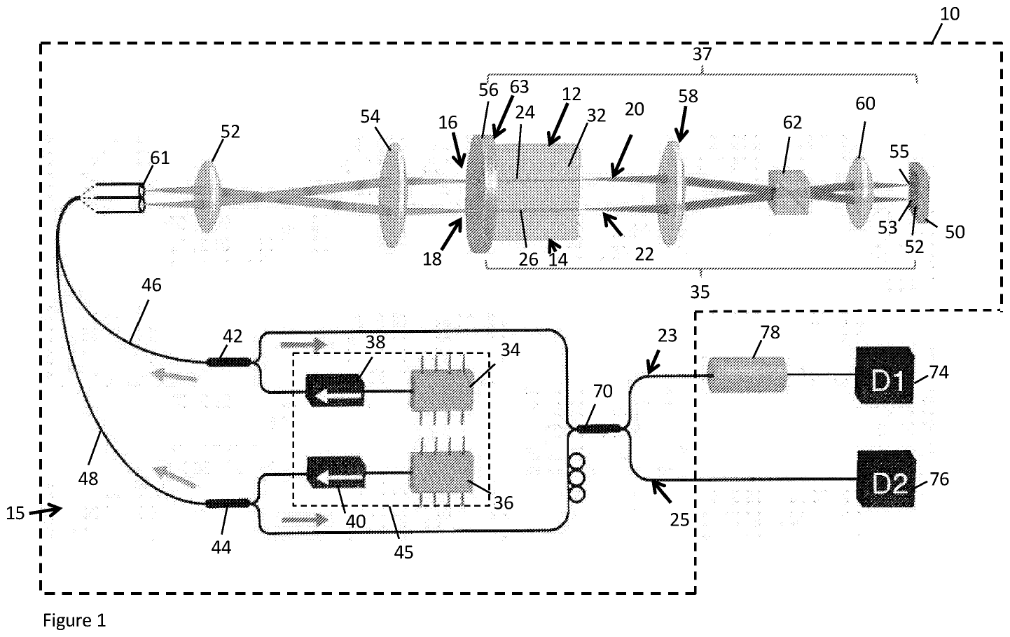

FIG. 1 shows an embodiment of an optical plural-comb generator generally indicated by the numeral 10. In this embodiment, the optical plural-comb generator 10 is an optical dual comb generator, but other embodiments generate more than two optical combs. The optical plural-comb generator 10 comprises a plurality (two, in this embodiment) of mode-locked lasers 12, 14 for generating a plurality of optical combs 20,22. The plurality of mode locked lasers 12,14 are mechanically coupled and optically independent. The optical plural-comb generator 10 comprises an optical combiner 15 optically coupled to an output 16, 18 of each of the plurality of mode-locked lasers 12, 14 for combining the plurality of optical combs 20, 22 when generated by the plurality of mode-locked lasers 12, 14. In this but not necessarily all embodiments, the optical plural comb is within optical fiber 23, 25.

In the context of this document, mechanically coupled means that the plurality of mode-locked lasers are cooperatively configured for externally generated mechanical perturbation (examples of which include but are not limited to externally generated vibrations, for example generated by a passing vehicle or a machine such as a compressor, and other environmental noise) to be synchronous at each of the plurality of mode-locked lasers. For example, in the present embodiment the length of the optical resonator 35,37 of each of the plurality of mode-locked lasers change at the same time and by the same amount in response to an externally generated vibration. The interference signal generated by the superposition of the plurality of optical combs 20,22 is unperturbed by the mechanical perturbations because there is common-mode rejection of the externally generated mechanical perturbations.

In the context of this document, optically independent means that the mode-locked lasers 12,14 are configured to eschew coupling of an optical comb 20, 22 from one of the plurality of mode-locked lasers 12,14 to another one of the plurality of mode locked lasers 14,12. The electromagnetic radiation when generated within the optical resonator 35,37 in any one of the plurality of mode-locked lasers 12,14 is not coupled (e.g. by evanescent coupling) into the optical resonator 37,35 of any other of the plurality of mode locked lasers 14,12. That is, the optical plural-comb generator 10 is configured for the plurality of optical combs 20,22 within the mode-locked lasers 12,14 when generated to be electromagnetically isolated from each other.

The plurality of mode-locked lasers 12, 14 each comprise a respective waveguide 24, 26 formed in a piece of solid-state laser gain material 32 common to (i.e. shared by) the plurality of mode-locked lasers 12,14. A common piece of solid state laser gain material is one example of how the mode locked lasers can be mechanically coupled to improve mutual stability of the plurality of optical combs 20,22. The piece of laser gain material 32 is in the form of a chip. The piece of laser gain material may be, but not necessarily, 6 mm-20 mm in length, 2 mm to 5 mm thick, and 5 mm to 15 mm wide. The plurality of waveguides 24,26 are laser-written into the piece of laser gain material 32, so that they are embedded waveguides that may be, for example, 150 μm to 600 μm interior to a surface of the laser gain material. The end facets of the laser gain material 32 (which are optical inputs and/or outputs) are perpendicular to the waveguides, and coated with an optical film to reduce optical Fresnel reflections, and protect the facet. In the present embodiment, the piece of laser gain material 32 comprises Er-doped ZBLAN, however it may comprise generally any suitable laser gain material examples of which include but are not limited to a glass doped with rare-earths, doped low phonon energy glasses, a crystal doped with rare-earths, and a semiconductor material, for example gallium arsenide. The waveguides may have any suitable structure and be formed using any suitable technique, for example etching and material deposition. The waveguides 24, 26 may generally have lower dispersion and optical nonlinearity than fiber waveguides that may reduce optical plural comb quality, because they have a compact size (having spatial dimensions (for example length, of less than 50 mm) and so minimal dispersion may be introduced. The waveguides 24,26 each have a transverse dimension (in this embodiment a diameter) in the range of 10 μm to 80 μm, however other embodiments may have other diameters. The ZBLAN glass is doped with 0.5 molar % Er³⁺ that is the active ion and 2 molar % of Yb³⁺ which enhances optical pump absorption, and 5 molar % of Ce³⁺, which reduces excited-state absorption in Er³⁺. The plurality of mode-locked lasers 12,14 may be arranged such that the plurality of optical combs 20,22 when generated are incident on the chip 32 at an angle in the range of 80 degrees and 90 degrees. The angle may be in the range of 80 degrees to 89.5 degrees.

Common mode rejection of mechanical noise is facilitated by adjacently disposing the waveguides 24,26 in the laser gain material 34 such that the waveguides 24,26 are sufficiently close to experience the same mechanical and thermal effects (which is a common noise). The maximum separation of the waveguides 24,26 for common mode rejection may be determined according to trial and error experiments in the environment that the optical plural-comb generator 10 is to operate. The minimum separation of the waveguides 24,26 such that electromagnetic wave coupling between the waveguides 24,26 has negligible effect on the optical comb generator 10 may also be determined by trial and error experiments for given waveguide parameters, or may be computed using optical waveguide coupling equations.

A mechanical perturbation to a common optical resonator component 56, 32, 58, 62, 60, 50 is experienced by both of the mode-locked lasers 12,14. Common mode rejection of mechanical noise is also facilitated by the mode locked lasers comprising common optical components 56, 32, 58, 62, 60, 50.

A slight effective optical resonator length difference (where 30 kHz corresponds to an effective path length difference at 800 MHz repetition rate of ˜7 μm) can be conveniently achieved by selecting waveguides adjacent to each other that have different transverse dimensions, but ensuring they still operate robustly on a single transverse mode. A difference in a waveguide diameter transverse dimension introduces a difference between the cavity optical path length between the waveguides 22,24, while generally holding all other laser characteristics constant. Different optical path lengths may also be achieved by, for example, wedging the ends of the laser gain material 32, introducing non identical curvatures to the waveguides, or inducing a temperature gradient across the laser gain material, by for example heating a transverse edge of the laser gain material 32, and providing a heat drain at an opposite transverse edge of the laser gain material.

Each of the plurality of mode-locked lasers comprise a reciprocal optical resonator, that is an optical resonator that supports a bi-directional propagation of the electromagnetic field therein, examples of which include a linear optical resonator, and a Z optical resonator.

An optical pump light source 45 comprises in this embodiment two laser diodes (LDs) 34,36 (Thorlabs BL976-PAG900). Other embodiments may have one or more than two laser diodes or other pump light generators, for example a solid-state or fiber lasers. The optical pump light source 45 generates a pump light that is introduced into the solid-state laser gain material 32 to optically pump the solid state laser gain material 32. Each of the laser diodes 34,36 is capable of emitting 900 mW of light having a wavelength of 976 nm in a single-transverse-mode. The pump light generated by each of the laser diodes 34,36 pass through an associated optical isolator 38,40 (Lightcomm HPMIIT-976-0-622-C-1), which are optically coupled to an optical wavelength division multiplexer 42,44 in the form of an optical fiber optical wavelength division multiplexer. Generally, any suitable form of optical fiber optical wavelength divisional multiplexer may be used, for example a bulk optic wavelength division multiplexer. The end of the output fibers 46,48 of the wavelength division multiplexer 42,44 are stripped, brought in contact along their side, and sandwiched between two glass slides with adhesive. The distance between the cores of the ends 61 of the optical fibers 46,48 is 125 μm. The end facets of the optical fibers lie in the same plane. The ends 61 of the optical fibers 46,48 are proud of the edge of the two glass slides.

The output plane is imaged onto the optical gain material 32 with a pair of lenses 52,54, arranged such that the distance between them is the sum of their focal lengths, so as to couple the pump beams into the waveguides 24,26, which are separated by 600 μm (center-center). The lenses 52,54 are chosen so that the ratio of the focal lengths match the required magnification set by the distance between waveguides 24,26 and that between fiber cores (4.8 in this but not necessarily in all embodiments). The parallel waveguides 24,26 have diameters of respectively 45 μm and 50 μm, which provides a balance between mode matching and pump confinement. The waveguides' relatively large area may support greater optical output power by keeping intra-waveguide optical irradiances relatively low, which my increase the power threshold for undesirable nonlinear effects.

An input coupler 56, which also acts as an output coupler, is butted-up against a facet 63 of the laser gain material 32 so as to pass more than 95% of the pump light, and reflect 95% of the optical combs 20,22 within the optical resonators 35,37 The optical resonators 35,37 are configured such that the resonator mode for each of the waveguides 24,26 is established by the arrangement of the relay imaging lenses 56,60 placed in the resonators 35,37.

Generally, any suitable optical pump light generator (e.g. fiber laser optical pump sources, integrated optical pump sources) and ways to couple the pump light into the waveguides (e.g. evanescent coupling) may be used.

The generator 10 comprises a mode-locking device 50 common to the plurality of mode-locked lasers 12,14. The mode-locking device 50 comprises a passive mode locking device in the form of a saturable-absorber mirror (SAM) (BATOP SAM-1550-15-12ps). Each of the plurality of optical combs 20,22 are spatially spaced apart at the mode-locking device, which may avoid nonlinear coupling between the plurality of optical combs at the SAM 50. Generally, any suitable form of mode locking device may be used, including but not limited to a two dimensional saturable absorber material, examples of which include but are not limited to graphene or other mode locking device.

The plurality of mode-locked lasers 12,14 are configured for the plurality of optical combs 20, 22 to each have a waist 53,55 adjacent the mode locking device 50.

The relay lenses 58,60 image the waveguide mode of each waveguide 24,26 onto different regions of the saturable-absorber mirror 36. By selecting the ratio of the focal lengths of the relay lenses 58,60, the size of each waveguide mode incident on the saturable absorber 50 may be accurately controlled, controlling the energy of the incident pulses of light constituting the optical combs 20,22 on the saturable absorber 50. The relay lenses 58,60 are separated by the sum of their focal lengths and are used to image the waveguide modes onto the SAM with a magnification of 0.16. This transverse size reduction increases the fluence on the SAM, and thus its saturation, which facilitates mode-locking of the optical combs 20,22. An intra-cavity polarizer 62 in the form of a polarization beam splitter is placed between lenses 58,60, where collimated beams cross, to allow a single linear polarization in the cavities. This allows only one polarisation mode, in this embodiment a linear polarisation mode, to operate in each of the plurality of optical combs 20,22, which was found to improve relative frequency difference stability. The common optical components 56, 32, 58, 62, 60, 50 generally enhances mutual stability.

By arranging the waveguides 24,26 in close proximity, near identical mode-locked lasers may be realised. Near identical mode-locked lasers mean laser emissions which have similar power, beam-quality, spectral line-shape, temporal pulse width, and repetition rate. The adjacent mode-locked lasers 12,14 are found to be stable relative to each other (or mutually coherent) without any electronic stabilization. The mode locked lasers 12,14 are configured so that they have a slight frequency detuning (Δfᵣ) with respect to each other, thus producing a low frequency beat, or interferogram at a repetition rate of ˜1/Δfᵣ.

The resulting optical combs 20,22 exit at the output coupler 56 and travel back towards the optical fibers 46,68 to be collected. They are separated from the counter-propagating pump light by the wavelength-division multiplexers 42,44 (Lightcomm HYB-B-S-9815-0-001). This results in optical combs 20,22 being within optical fiber, and which can be superimposed in an optical coupler 70 in the form of an optical fiber coupler that is a 50/50 splitter, to perform dual-comb spectroscopy. The power of each optical comb is ˜2 mW on the exterior side of the optical coupler 56, of which approximately a tenth is successfully coupled in to the fibers 46,48. Alignment is, in the present but not necessarily all embodiments, optimized for a wavelength of the pump light.

The plurality of mode-locked lasers 12,14 is configured such that the plurality of optical combs 20,22 are incident on the chip 32 at an angle in the range of 80 degrees and 90 degrees. The chip 32 is mounted on a rotatable stage, for example, and the rotatable stage rotated for manual tuning of the angle. This may reduce reflections that may cause parasitic spurious oscillations in the cavity that can disrupt the stability of the mode-locking lasers.

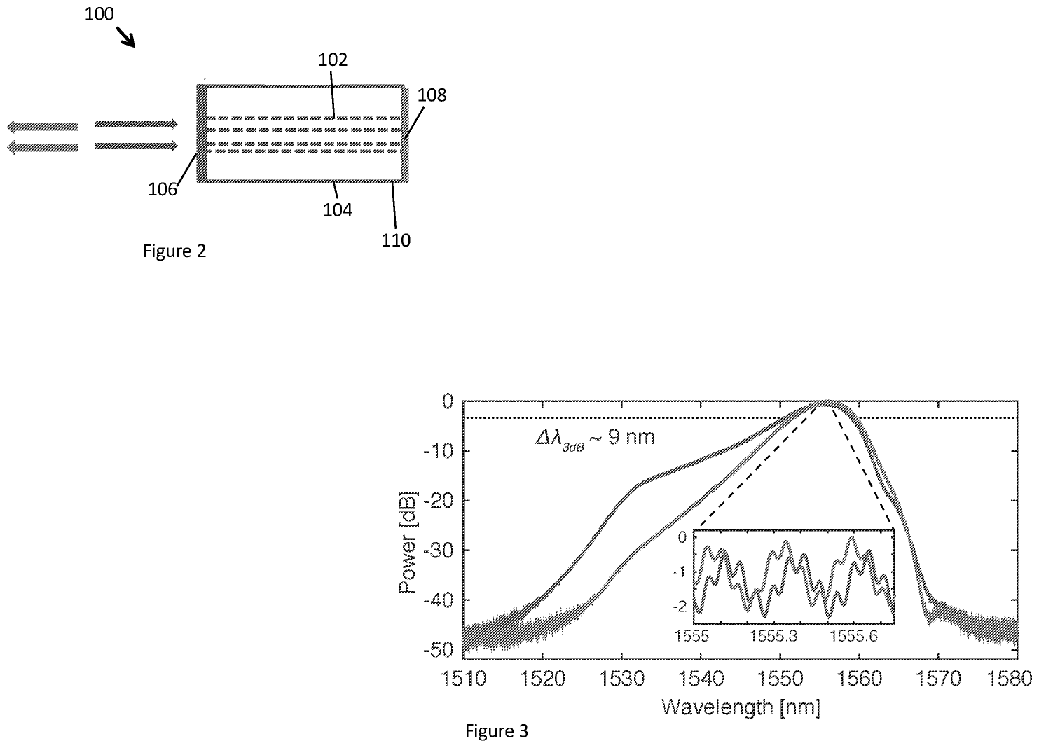

FIG. 2 shows an example of a plurality of mode-locked lasers 102,104 that are mechanically coupled and optically independent that may alternatively be used in the optical plural comb generator 10. The optical coupler 106 and the saturable absorber mirror 108 are directly deposited on the end facets of a piece of laser gain material 110. Embodiments using this configuration do not require bulk optic mirrors or lenses to generate the plurality of optical combs.

An embodiment of a method for generating an optical plural-comb will now be described. The method may be executed, for example, using the optical plural-comb generator 10. A step of the embodiment of the method comprises mechanically coupling a plurality of optically independent mode-locked lasers. A step comprises operating the mechanically coupled plurality of optically independently mode-locked lasers thereby generating a plurality of optical combs 20. A step comprises superpositioning the plurality of optical combs 20,22.

FIG. 3 shows the spectrum of each optical comb 20,22, as measured with an optical spectrum analyser (Anritsu MS9470A). Their 3-dB bandwidth (Δλ_{3dB}) spans approximately 9 nm around 1555 nm and they show relatively good spectral overlap. A zoomed view reveals spectral modulation that is identified as parasitic reflections taking place on the left surface of the output coupler 56 and on the right surface of the chip 34. Even though anti-reflective coatings are deposited on those surfaces, the weak echoes are re-amplified through the chip 34 and come out with non-negligible power. This issue may be solved with an angled chip and a wedged output coupler.

The repetition rate (fᵣ) of each comb is 822.4 MHz and their repetition rate difference (Δfᵣ) is 10.5 kHz. This yields a beat spectrum fully contained within a single comb alias. Its central frequency is adjustable by varying one of the diodes' pump power. Δfᵣ is mostly determined by the slight optical path differences between the two resonators and, potentially, through waveguides. Their waveguide diameters differ and this may affect their effective modal indices. Tuning Δfᵣ is possible by slightly adjusting the alignment of optical components. An optical dual comb source has a frequency difference between the two optical combs, which then allows the two combs to mix when incident on a suitable detector. The frequency difference is ƒᵣ₁−ƒᵣ₂=Δf where Δf is a low frequency (˜<30 kHz), and ƒ_{r1,2} are ˜822 MHz. Hence readout is achieved by recording the low frequency interference, and it is converted back into the frequency domain by use of a Fourier Transform.

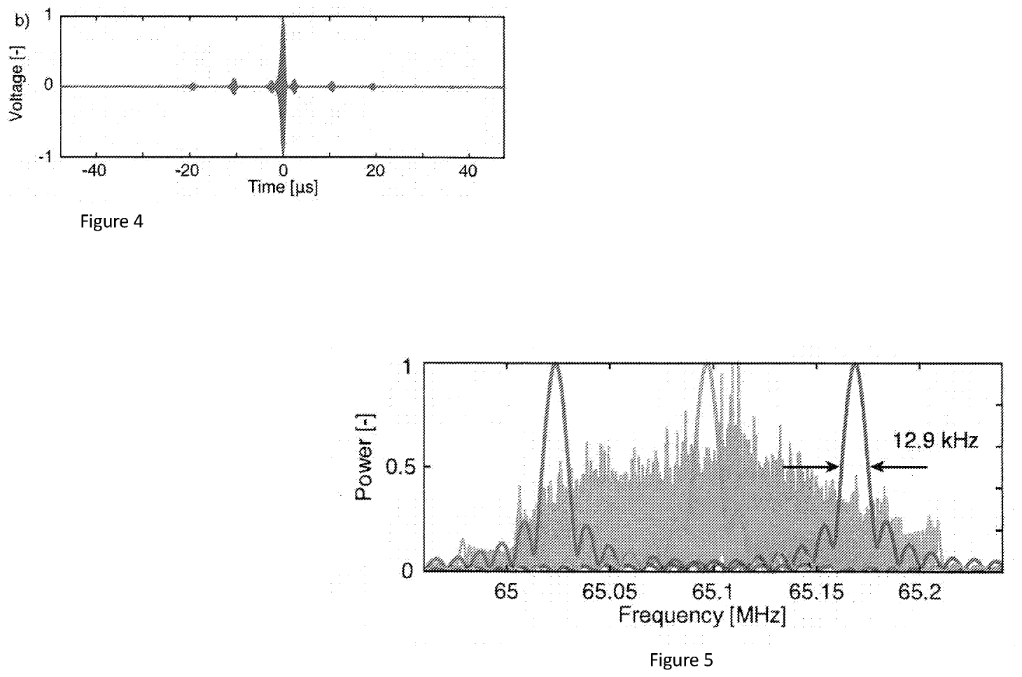

FIG. 4 shows an averaged interferogram obtained with a sequence of interferograms self-corrected using an algorithm

The consistency of the beat note (interferogram) between the two optical frequency components of each optical comb are directly related to the mutual stability of the optical frequency combs 20,22.

FIG. 5 shows the spectrum of a pair of optical comb modes beating together at different times, used to measure the mutual stability of the comb. A continuous wave laser is mixed with a comb line of each laser to create a beat note. The beat note is computed from collecting the output of the optical dual-comb generator 10 for 71 ms using a fast photodetector electrically coupled to an analogue to digital converter taking 1×10⁹ samples per second. The 71 ms period corresponds to the analogue to digital converter's memory depth at 1 GS/s. FIG. 5 also shows three beat notes computed from three shorter integration periods of 1/Δfᵣ˜95 microseconds within the total 71 ms integration period. The beat notes are nearly transform-limited because their width (˜12.9 kHz) approaches the bandwidth of a rectangular window (1.2 Δfᵣ=12.6 kHz). This suggests that the optical dual-comb generator 10 is stable on a 1/Δfᵣ timescale, which corresponds to the time between interferograms, and is an enabler for self-correction algorithms for dual comb spectroscopy. However, the interferogram's central frequency slowly drifts over time and turns into the wider grey trace (>10 Δfᵣ) after 71 ms of integration. This is mostly due to vibrations that slightly change the coupling of the pumps into the waveguides as well as the alignment of optical resonator optics.

The applicants have demonstrated the mutual coherence of the frequency comb lasers and their relative frequency difference stability by precisely measuring the spectroscopic absorption of a molecular gas (HCN) 72. One optical comb may be used to read-out the other optical comb, using dual-comb spectroscopy.

An embodiment of a free-running dual-comb spectrometer incorporates the optical plural comb generator 10. The dual-comb spectrometer is shown in FIG. 1 and includes the peripherals to the optical comb generator 10, including detectors 74,76, and a sample interrogation zone in the form of a gas cell 78. The optical plural comb generator 10 has relatively high stability, which may allow full resolution of the optical plural comb optical frequencies, after tracking and correction of residual drifts that may be estimated from interferograms. No single-frequency lasers, external signals or control electronics may be required.

Although nothing forces the two combs 20,22 to settle individually at specific frequencies, the platform presented here is designed so as to ensure a certain level of relative stability between them. Therefore, the frequency difference between pairs of comb frequency component is much more stable than their absolute frequencies. This is what is required for mode-resolved dual-comb spectroscopy since the measured interferogram is a new electrical comb with modes sitting at those differential frequencies.

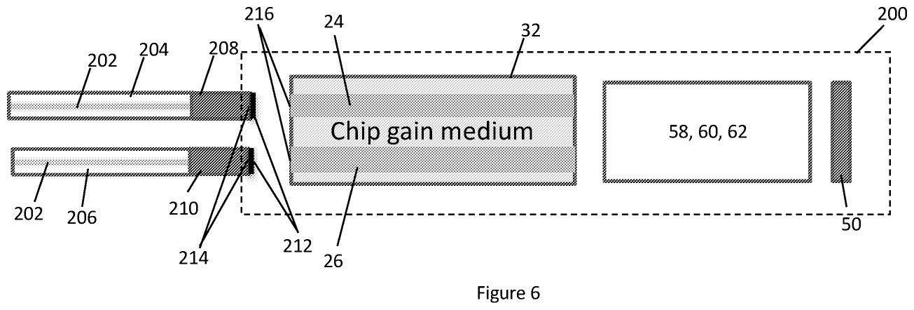

FIG. 6 shows another example of a plurality of mode-locked lasers 200 that are mechanically coupled and optically independent that may be used in the optical plural comb generator 10 of FIG. 1, wherein parts that are similar and/or identical in form and/or function to those in FIG. 1 are similarly numbered. The pump light 202 is introduced without the use of lenses 52 and 54. The pump light is directly launched into each waveguide 24,26 from the ends of a fiber 204, 206 for guiding the pump light. A section of mode converter optical fiber 208,210 may be spliced to each of the fibers 204, 206 for guiding the pump light to enhance the coupling of the pump light 202 into each waveguide 24,26. The sections of mode converter optical fiber 208,210 may comprise less than 1 mm of multi-mode graded index fiber. The short length of multi-mode fiber may allow reduction in system size and increased robustness. In this and other embodiments, the resonator coupler 56 is replaced by a dielectric mirror coating 212 applied to the proximal face 214 of the fibers 208, 210. The length of each cavity is dependent on the distance between then proximal face of the dielectric mirror coating 212 and the outward face 216 of the waveguide 32.

In the example of FIG. 6, the piece of laser gain material 32 is 11 mm long and comprises erbium-doped ZBLAN glass. The waveguides 24,26 are embedded in the laser gain material 32, comprise depressed-claddings and are formed by femtosecond laser inscription. The waveguides 24,26 are adjacent. The waveguides 24,26 have a core diameter of 45 μm and have a center-to-center distance of 400 μm. The dielectric mirror coating 212 is transparent at the pump light wavelength of 976 nm and 97.5±0.5% reflective across the 1500-1600 nm optical wavelength band. The optical combs comprise a pulse train having a mean repetition rate (ƒᵣ) of 1 GHz, and a repetition rate difference (dƒᵣ) of 50 kHz, and a 3 dB spectral bandwidth of ˜6 nm.

To evaluate the free-running frequency noise performance of the optical dual comb generator using the plurality of mode locked lasers of FIG. 6, each comb output is mixed with light from a 1530 nm continuous-wave (CW) laser and the resulting signals are measured simultaneously with an oscilloscope. A frequency noise power spectral density (PSD) is then calculated for each comb-CW beat note with the mode that is closest to the CW laser.

The CW laser used for this measurement is an external cavity diode laser (RIO Planex) with a 10 kHz linewidth. In order to estimate the CW laser's contribution to the comb-CW beat notes, its own frequency noise PSD is measured using an environmentally stable fiber-based Mach-Zender interferometer operating in the coherent discriminator regime

The upper limit on the free-running frequency noise PSD of each of the two optical combs output by the plural comb generator 200 was measured to be less than 1×10⁶ Hz²/Hz at frequencies between 1 kHz and 10 MHz, and less than 1×10⁴ Hz²/Hz at frequencies greater than 10 kHz. Digitally beating the two measured comb-CW beats cancels the CW laser's contribution and yields information on the relative stability, or mutual coherence, of the dual-comb source. The two optical combs have a mutual Lorentzian linewidth of less than 50 Hz. The common mode rejection of vibrations generated by clapping near the generator and swift knocking on the structure supporting the generator in the range of 1 Hz to 10 KHz was measured to be reduced by at least 10 times, in this embodiment 100 times, by mixing a comb with a low-noise continuous-ware diode laser. The measured frequency noise was 10¹⁰ Hz²/Hz at 1 Hz). The mutual coherence time of the two optical combs generated by the plurality of mode-locked lasers 200 is greater than 1 s.

In the embodiments disclosed herein and other embodiments, two pieces of solid-state laser gain material may be used, one for each waveguide. The pieces of solid-state laser gain material may be diffusion bonded onto a substrate or intermediate piece of non-doped material, for example. The two pieces may be held within a common clamping structure. Two attached and parallel pieces of rare-earth ion doped optical fiber may be used. Generally, any suitable configuration of solid state laser gain material or materials may be used, as long as common mode rejection is provided.

The waveguides 24,26 are written into the laser gain material 34 using an ultrafast laser in the form of, for example, a femtosecond laser. The laser light is generally focused using an objective lens into the laser gain material 34 to generate a focal spot of sufficient intensity to form a plasma resulting in nonlinear optical breakdown of the optical material. The plasma is of a temperature of several thousand degrees Kelvins, and forms a melted ball of optical material having a diameter of around 50 μm. The rapid cooling, compared to the slow cooling when the optical material was first formed, results in a different refractive index at the focal spot. This alters the structure of the glass. The focal spot (or optical material) is translated to form each waveguide. The dimensions and index contrast of the waveguides 24,26 may be changed by changing the laser pulse energy and the rate at which the focal spot is translated.

Now that embodiments have been described, it will be appreciated that some embodiments may have some of the following advantages:
Embodiments may have many components shared by the mode-locked laser optical resonators to enhance rejection of common-mode noise, which may reduce or eliminate the effect of environmental noise such as vibration, improving frequency stability.
Embodiments do not have cross-coupling of the optical combs because the optical combs independently interact with the saturable absorber and optical gain medium, for example.
Embodiments may be compact in view of integration with the gain material.
Embodiments may have mutually stable optical frequency combs.
The spectral frequencies of the frequency combs generated by embodiments may be fully resolved using an algorithm that corrects residual relative fluctuations estimated from the spectroscopic interferograms.
Embodiments may not comprise a single-frequency laser for mutual coherence, control electronics for mutual coherence or be configured to receive an external signal generator for mutual coherence, which may simplify the device.
Relatively short and relatively large-mode-area waveguides ensures that Kerr non-linearity remains negligible to minimize excess noise.

Variations and/or modifications may be made to the embodiments described without departing from the spirit or ambit of the invention. For example, an embodiment of an optical plural comb generator may generate at least three optical combs. The optical combiner may alternatively or additionally comprise free space optics, for example a mirror for each of the output optical combs that are arranged for the plurality of optical combs to cross each other. The optical-plural comb generator may be wholly integrated in a photonic chip. The waveguides may be formed by etching, or generally any suitable method. The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. An optical plural-comb generator comprising:
a plurality of mode-locked lasers that are mechanically coupled and optically independent; and
an optical combiner optically coupled to an output of each of the plurality of mode-locked lasers for combining a plurality of optical combs when generated by the plurality of mode-locked lasers.

2. An optical plural-comb generator defined by claim 1 wherein the plurality of mode-locked lasers are cooperatively configured for externally generated mechanical perturbations to be synchronous for the plurality of mode-locked laser.

3. An optical plural-comb generator defined by claim 1, wherein the plurality of mode-locked lasers are cooperatively arranged for externally generated vibrations to be synchronous for the plurality of mode-locked lasers.

4. An optical plural-comb generator defined by claim 1, wherein the plurality of mode-locked lasers are cooperatively arranged such that the length of an optical resonator of each of the plurality of mode-locked lasers change at the same time and by the same amount in response to an externally generated vibration.

5. An optical plural-comb generator defined by claim 1, configured to eschew coupling of the optical comb from one the plurality of mode locked lasers to another of one of the plurality of mode locked lasers.

6. An optical plural-comb generator defined by claim 1, wherein each of the plurality of mode-locked lasers comprise a waveguide formed in a piece of solid-state laser gain material common to the plurality of mode-locked lasers.

7. An optical plural-comb generator defined by claim 6 wherein the effective length of an optical resonator of one of the plurality of mode-locked lasers is 1 μm-100 μm greater than the effective length of another optical resonator of another one of the plurality of mode-locked lasers.

8. An optical plural-comb generator defined by claim 6, wherein the distance between the centers of adjacent waveguides of the plurality of the mode locked lasers is 100 μm to 1 mm.

9. An optical plural-comb generator defined by claim 8 wherein the distance between centers of adjacent waveguides of the plurality of mode locked lasers is 300 μm to 600 μm.

10. An optical plural-comb generator defined by claim 6, wherein the respective waveguide of each of the plurality of mode locked lasers has a length of less than 150 mm.

11. An optical plural-comb generator defined by 6, wherein the respective waveguide of each of the plurality of mode locked lasers has a length of less than 75 mm.

12. An optical plural-comb generator defined by claim 6, wherein the respective waveguide of each of the plurality of mode-locked lasers has a length of less than 20 mm.

13. An optical plural-comb generator defined by claim 6, wherein the respective waveguide of each of the plurality of mode-locked lasers has a length of at least 0.5 mm.

14. An optical plural-comb generator defined by claim 6, wherein the plurality of mode-locked lasers are arranged such that the plurality of optical combs when generated are incident on the piece of solid state laser gain material of at an angle in the range of 80 degrees and 90 degrees.

15. An optical plural-comb generator defined by claim 1, wherein a waveguide of one of the plurality of mode locked lasers has a different dimension than that of another waveguide of another one of the plurality of mode locked lasers.

16. An optical plural-comb generator defined by claim 15 wherein the different dimension comprises at least one of a different length and a different transverse dimension.

17. An optical plural-comb generator defined by claim 15, wherein a transverse dimension of a waveguide of one of the plurality of mode-locked lasers is 1 μm to 25 μm greater than that of another one of the plurality of mode-locked lasers.

18. An optical plural-comb generator defined by claim 6, wherein the transverse dimension of the one of the plurality of waveguides is 2.5 μm to 10 μm greater than the transverse dimension of the other one of the plurality of waveguides.

19. An optical plural-comb generator defined by claim 6, wherein the transverse dimension of an optical core of each of the plurality of waveguides is 20 μm-100 μm.

20. An optical plural-comb generator defined by claim 1, wherein the length of an optical resonator of one of the plurality of mode-locked lasers is greater than that of another one of the plurality of mode-locked lasers.

21-44. (canceled)
